(19) United States
(12) Patent Application Publication
(10) Pub. No.: US 2024/0257664 A1
(43) Pub. Date: Aug. 1, 2024

(54) CATHETERIZATION TRAINING DEVICE

(71) Applicant: Christiana Care Health System, Inc., Wilmington, DE (US)

(72) Inventors: Catherine Burch, Bear, DE (US); John G. DiGiovanni, Wilmington, DE (US); Gwendolyn Ebbert, Bear, DE (US); John Evans, Landenberg, PA (US); Kelsey Kosinski, Wilmington, DE (US); Bridget Remel, Cochranville, PA (US); Kathryn L. Segura, Wilmington, DE (US)

(21) Appl. No.: 18/425,833

(22) Filed: Jan. 29, 2024

Related U.S. Application Data
(60) Provisional application No. 63/441,493, filed on Jan. 27, 2023.

(51) Int. Cl. G09B 23/28

(52) U.S. Cl. CPC G09B 23/285

(57) ABSTRACT

A catheterization training device includes a rigid housing defining an internal cavity, and a leg/torso body model constructed of lightweight material and storable within the internal cavity. The body model houses a urinary bladder model housed and a proximal urethra model defining a first canal in fluid communication with said urinary bladder model and terminating in a connector. The device further includes at least one genitalia accessory having a configuration of one of human male and human female genitalia. Each genitalia accessory defines a distal urethral model comprising a second canal terminating in a corresponding connector operable to form a mechanical interconnection with the connector of the body model to form a fluid-tight interconnection therewith, and a continuous canal through the distal urethra model and the proximal urethra model and into the urinary bladder model.

### CROSS-REFERENCE TO RELATED APPLICATION

This application claims the benefit of priority, under 35 U.S.C § 119(e) of U.S. Provisional Patent Application No. 63/441,493, filed Jan. 27, 2023, the entire disclosure of which is hereby incorporated herein by reference.

### FIELD OF THE INVENTION

The present invention relates generally to training tools for healthcare providers, and more particularly to a catheterization training device including bodily tissue model structures for teaching and/or practicing urinary catheterization procedures.

### DISCUSSION OF RELATED ART

There is a common need in healthcare for nurses and other medical/clinical healthcare providers to perform a urinary catheterization procedure on human patients. Medical/nursing students and other clinicians need to undergo training and learn such procedures before performing such procedures on human patients. Additionally, it has been recognized to be desirable for fully-qualified clinicians to be able to occasionally practice such procedures, e.g., immediately before performing such a procedure on a human patient, to ensure that such procedures are performed correctly.

Improper performance of a urinary catheterization procedure can result in various problems. For example, improper aseptic insertion of a urinary catheter during the urinary catheterization procedure can cause Catheter-Associated Urinary Tract Infections (CAUTIs). CAUTIs are a metric measured by healthcare organizations to assess patient care outcomes. The Centers for Medicare & Medicaid Services, The Joint Commission, and other regulators use this metric as well. Although providers are formally trained in the urinary catheterization procedure, the infrequency with which the procedure is performed can lead to a failure to meet applicable standards of care.

Some rudimentary training devices exist that include models of human body tissues. Many of such models typically include only one of male genitalia and female genitalia, despite the need to perform catheterizations on both males and females. Some such models include large-scale (e.g., life-size) human-form body models including a torso, legs and/or genitalia, typically made of silicone and plastic, that are large, heavy, bulky and difficult to store. Accordingly, organizations typical centralize storage and access, away from clinical settings, to medical manikins used for training purposes because of the cost, size, and weight of such manikins.

What is needed is a compact, lightweight and/or portable catheterization training device suitable for storage in a clinical setting, to provide readily-available access to clinicians in the clinical setting, that allows providers to practice/train catheterization procedures for males and females more often, and in close proximity to (e.g., immediately before) a catheterization procedure, thus reducing the risk of improperly-performed catheterization procedures, and associated patient infections.

### SUMMARY

The present invention provides a catheterization training device that allows providers to be trained in, and to practice, catheterization procedures for both males and females. The catheterization training device is compact, lightweight and portable, and thus well-suited for storage in a clinical setting to provide readily-available access to clinicians in the clinical setting, and in close proximity to (e.g., immediately before) a catheterization procedure, thus reducing the risk of improperly-performed catheterization procedures or improper perineal care/maintenance, and associated patient infections. Further, the device includes relatively-extensive human anatomy to facilitate practicing/training of the full catheterization procedure (from initially creating a sterile field to post-procedure clean up), physically close to patient care locations.

An exemplary catheterization training device comprises a rigid housing defining an internal cavity, and a leg/torso body model constructed of lightweight material and storable within the internal cavity. The body model houses a urinary bladder model housed and a proximal urethra model defining a first canal in fluid communication with said urinary bladder model and terminating in a connector. The device further includes at least one genitalia accessory having a configuration of one of human male and human female genitalia. Each genitalia accessory defines a distal urethral model comprising a second canal terminating in a corresponding connector operable to form a mechanical interconnection with the connector of the body model to form a fluid-tight interconnection therewith, and a continuous canal through the distal urethra model and the proximal urethra model and into the urinary bladder model.

### BRIEF DESCRIPTION OF THE FIGURES

An understanding of the following description will be facilitated by reference to the attached drawings, in which:

FIG. 1 is a perspective view of a first embodiment of an exemplary catheterization training device in accordance with an exemplary embodiment of the present invention, shown with the housing in the closed (storage) position in which leg and torso tissue model structures are disposed inside an internal cavity of the housing;

FIG. 2 is a perspective view of the exemplary catheterization training device of FIG. 1, shown with the housing in a partially open position;

FIG. 3 is a perspective view of an exemplary catheterization training device of FIG. 1, shown with the housing in an open (operative) position in which leg and torso tissue model structures are disposed outside the internal cavity of the housing;

FIG. 4 is a perspective view of an exemplary catheterization training device of FIG. 1, shown with the housing in the open (operative) position with a male genitalia accessory attached;

FIG. 5 is a front view of an exemplary catheterization training device of FIG. 1, shown with the housing in the open (operative) position with the male genitalia accessory attached; and

FIG. 6 is a perspective view of a second exemplary catheterization training device of FIG. 1, shown with the housing in the open (operative) position with a female genitalia accessory attached;

FIG. 7 is a perspective view of an exemplary catheterization training device of FIG. 1, showing certain additional structures of the device; and

FIGS. 8 and 9 are perspective views of the exemplary catherization training device is use with male and female genitalia model accessories, respectively.

### DETAILED DESCRIPTION

The present invention provides a compact, lightweight and/or portable urinary catheterization training device 100 configured to provide readily-available access to clinicians in the clinical setting, that allows providers to be trained in, and to practice, indwelling catheterization procedures for males and females, as well as external urinary collection device procedures, and perineal care and maintenance procedures. Accordingly, the device is suitable for use by licensed caregivers (e.g., for catheterization procedures) and unlicensed caregivers (e.g., for perineal care procedures) alike. Notably, the device is particularly advantageous to licensed caregivers, in that it is well-suited to allow such caregivers to practice relevant procedures more often, and in close proximity to (e.g., immediately before) a catheterization procedure, thus reducing the risk of improperly-performed catheterization procedures, and associated patient infections, due in large part to its light weight and unique features making it readily storable in a clinical setting in compact and stable fashion. Additionally, the device may be configured as a self-contained device that houses/stores all necessary human body part models as well as all supplies associated with proper catheterization procedures to function as a complete self-contained catheterization kit.

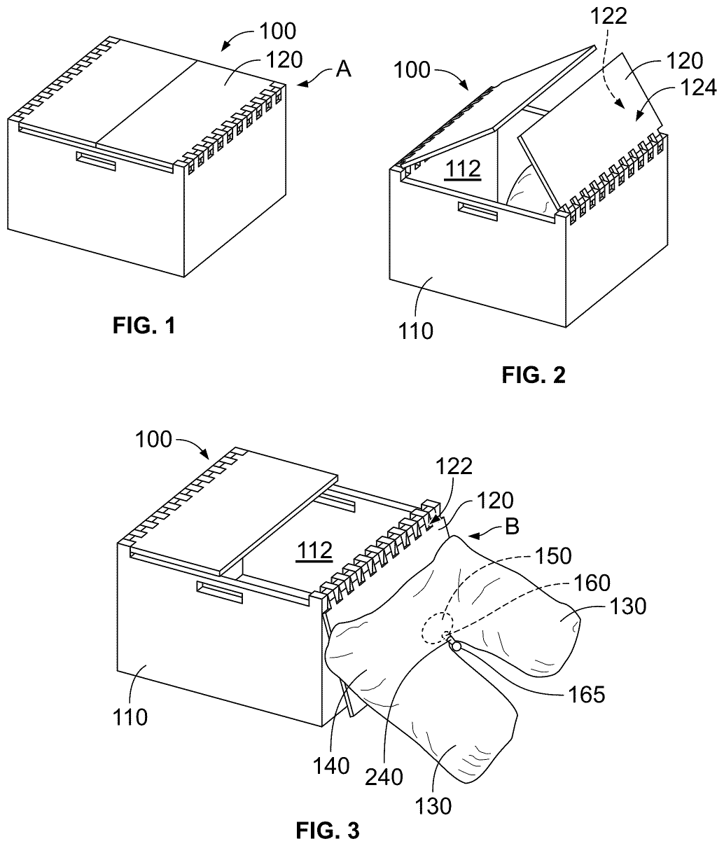

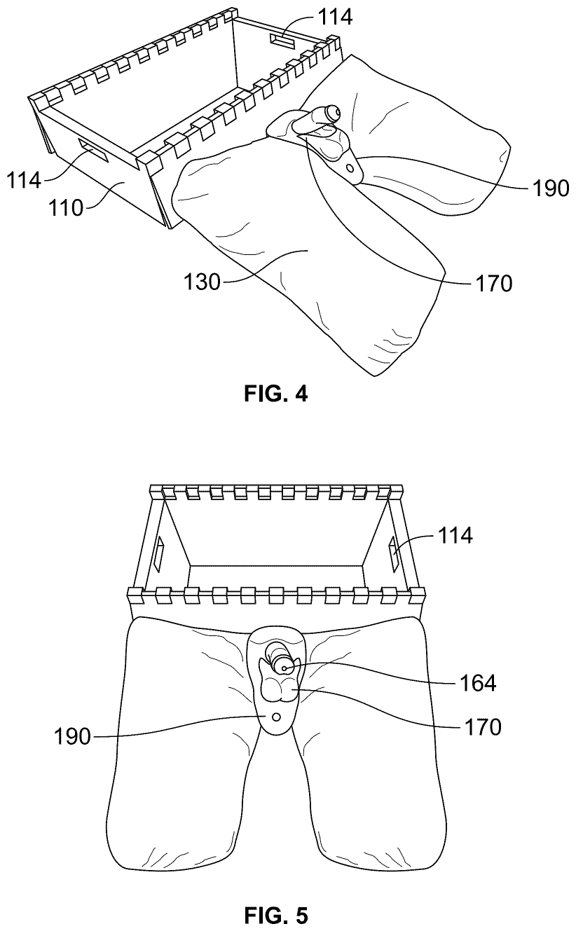

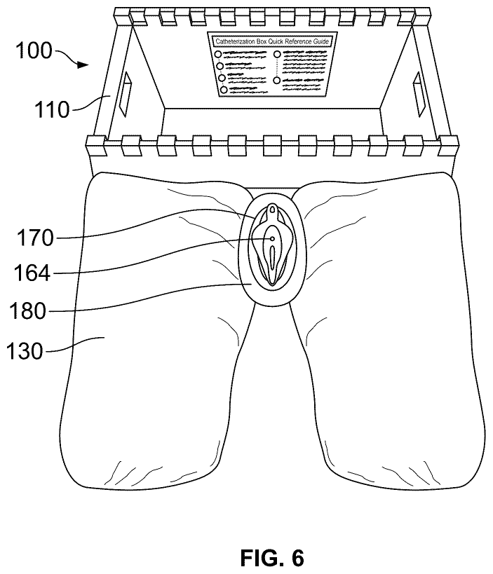

An exemplary device includes a rigid housing 110 defining, in a closed configuration, an internal cavity 112 having a volume sufficient for the device to be self-contained, in that it includes storage for working portions of the device, including any detachable components and materials associated with a catheterization procedure. The housing 110 may be strictly cuboid (as shown in FIGS. 1-3 and 7), or not strictly cuboid (e.g., as shown in FIGS. 4-6). The housing 110 preferably has an external surface such that it is configured to be readily stackable (e.g., an overall rectangular prism, trapezoidal prism, or other box-like shape), making it particularly suitable for storage in a clinical setting. An external (e.g., circumferential) lip/flange and/or handles/hand grips 114 may be integrated into the housing 110 to facilitate manually grasping and/or carrying of the housing 110/device 100, as shown in FIGS. 4 and 5.

The device 100 may be configured in an open configuration in which an interior of the housing 110 is accessible and open to the environment. In this exemplary embodiment, the housing 110 includes a movable flap 120 operable to move between a first position (A, FIG. 1), in which the housing 110 is in a closed storage position, with components of the device enclosed within the internal cavity 112 of the housing 110, and a second position (B, FIG. 3), in which the housing 110 is in an open operative position, with components of the device exposed (or exposable) outside of the internal cavity 112 of the housing 110. In certain embodiments, the partial leg 180 and/or partial torso 140 elements are not joined to the housing. In other embodiments, the partial leg 130 and/or partial torso 140 elements are joined, permanently or releasably, to an inner surface of the housing. In the exemplary embodiment of FIGS. 1-5, the partial leg 130 and partial torso 140 elements are joined to an inner surface 122 of the movable flap 120 portion of the housing 110, as shown in FIG. 3.

Inclusion of the leg and torso elements 130, 140 as part of the device can be advantageous, since it allows for more robust practice of not only the catheterization itself, but also necessary steps before, during and after the actual insertion of the catheter (e.g., involving preparatory cleaning steps, creation/maintenance of a sterile field, equipment preparation steps, securing the catheter to the leg, and clean-up steps) that are associated with the catheter insertion and part of a proper catheterization process, and that generally involve the upper thigh and lower torso body parts. Accordingly, the device offers students and clinicians real-world scenarios for practice, patient safety and improvement of satisfaction measures, in adherence to relevant regulations, guidelines, and safety measures.

The leg and/or torso elements 130, 140 house internal body tissue model structures relevant to a catheterization procedure, generally in anatomically correct or otherwise suitable positions. In particular, the internal body tissue model structures include at least a urinary bladder model 220 and a proximal portion 160 of a urethra model, which may be tube-like or otherwise define a urethral canal/conduit. The torso 140 (e.g., partial lower abdomen), and legs 130 (e.g., partial upper thighs) may be constructed of lightweight (e.g., relative to comparable parts made of silicone and/or plastic) and soft/bendable/compressible materials to facilitate their storage within the housing. By way of examples, these structures may be formed of a readily-cleanable and reinforced fabric-type material (e.g., vinyl, polyethylene, or polypropylene fabric) stuffed with a upholstery-type stuffing material, such foam, polyester “wool” filling, or the like. This allows the device to be much lighter than conventional silicone/plastic-type body models. Such materials are well-suited to making the leg/torso structures look realistic, and function in a manner mimicking human skin. The material is preferably selected to be readily cleanable/sterilizable, e.g., by wiping the surface with an iodine-, alcohol-, or oil-based cleaning solution.

The leg/torso elements may include a mounting structure 165 for mounting thereto a detachable genitalia model accessory 170 in an anatomically correct position adjacent the juncture of the leg elements 130. The mounting structure 165 further serves to ensure registration and alignment of the genitalia model accessory 170 in a predetermined position, to ensure registration and alignment of a distal portion 164 of a urethra model of the genitalia model structure accessory 170 with the proximal portion 160 of the urethra model of the leg/torso elements 130/140 (and the bladder 150) when mated thereto via the mounting structure 165 (and/or to a connector 240 at a terminal end of the proximal portion 160 of the urethra model), to ensure fluid communication therebetween.

The housing 110 is dimensioned such the internal cavity of the housing is sufficient in size to accommodate the leg/torso elements, as well as the detachable genitalia accessories 170, when the housing is in the closed (storage) position.

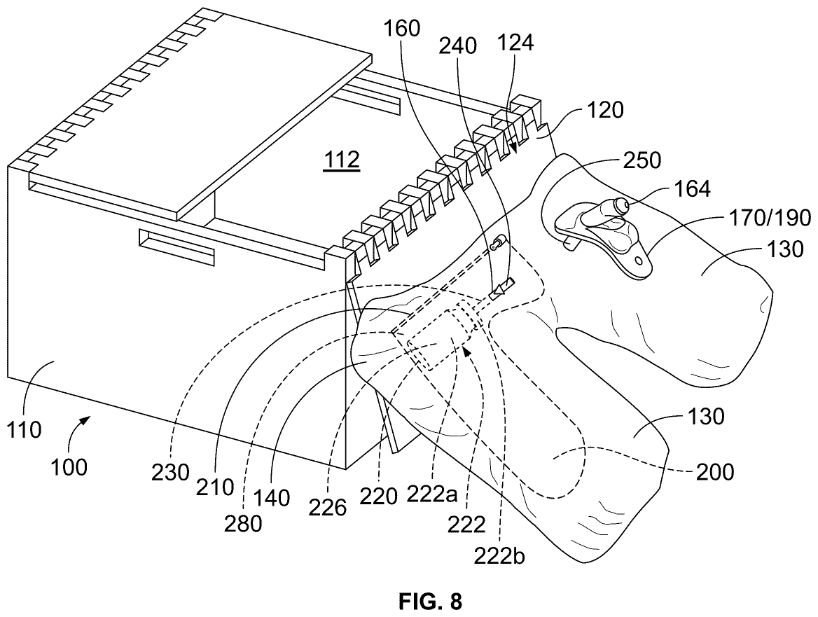

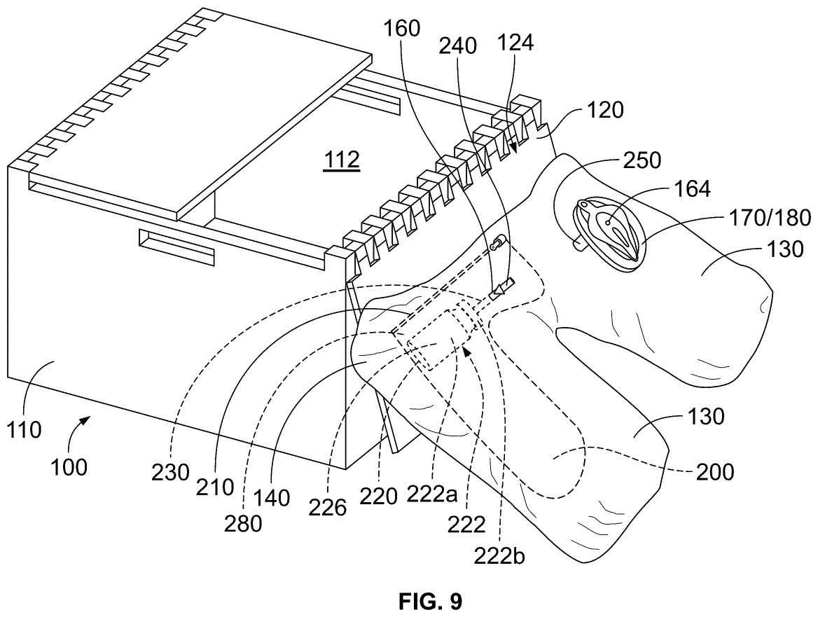

In one embodiment, genitalia accessories 170 may include an interchangeable female genitalia model accessory 180 and male genitalia model accessory 190, which are shown in greater detail in FIGS. 8 and 9. In an alternative embodiment, the leg/torso elements may include a fixedly attached female genitalia model 180 and a male genitalia model accessory 190 may be provided for attachment to/over the female genitalia model 180 by way of the mounting structure 165.

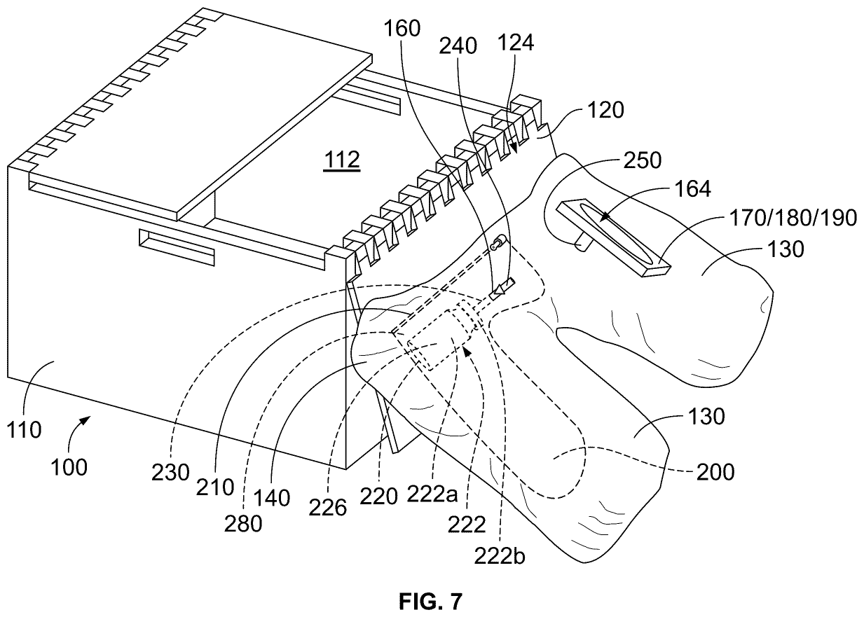

FIG. 7 is a perspective view of an exemplary catheterization training device 100 of FIG. 1, showing certain additional structures of the device. More particularly, the leg 130 and/or torso 140 elements define an internal cavity 200 that is closable by a closure 210. Positioned within the cavity are a bladder model 220 in fluid communication with a proximal portion 160 of the urethra model that terminates in a connector 240. The connector 240 is operable to form a mechanical interconnection with a corresponding connector 250 of the genitalia accessory and to form a fluid-tight interconnection therewith. Accordingly, when either the female genitalia model accessory 180 or male genitalia model accessory 190 is mated via its respective connector 250 to the connector 240, the proximal portion 160 and distal portion 164 of the urethra model are interconnected and in fluid communication with each other and with an internal cavity 224 of the bladder model 220.

In certain embodiments, the bladder model 220 and at least a portion of the proximal urethra model 160 may be housing within a pocket 280 internal to the body model, to separate the volume of the pocket from any stuffing of the body model. The pocket 280 may be closable by a reclosable fastener 290, such as a zipper, hook and loop fastener, or the like.

Preferably, the bladder model 220 includes a substantially closed container 222 (e.g., closed except for an outlet 224 open to the proximal portion 230 of the urethra model) that can be disassembled for cleaning or other access to a bladder cavity 226, e.g., in the nature of a bottle body 222a and a reclosable lid 222b configured to form a fluid-tight seal therewith). Preferably, the bladder cavity 226 is substantially larger in cross-section than the cross-section of the outlet, at least immediately adjacent the outlet, to allow for expansion of the catheter (e.g., a “balloon” of a foley catheter as part of a typical catheterization procedure). The bladder cavity 226 may define a volume comparable in size to a normal human bladder (e.g., in the range of approximately 350 ml-500 ml in volume). Connector 240 may be permanently fixed to the proximal urethra model tubing structure associated with the leg/torso element. The connector 240 may include structures to stabilize/attach the tubing structure to the leg/torso element by “sandwiching” the fabric between flanges on the connector 240. The genitalia accessories include a complementary mating structure and/or connector for forming a mechanical and fluid-tight seal with the connector 240, to form a continuous, fluid-tight urethral canal model through the genitalia accessories to the bladder.

The housing 110 is preferably further dimensioned such that the internal cavity 112 of the housing 110 is sufficient in size to accommodate not only the leg/torso elements and genitalia accessories, but also materials associated with a catheterization procedure (and/or practice of a catheterization procedure using the device), which may include a printed instruction guide, a urinary catheter, adhesive tape, a box of examination gloves, cleaning materials/wipes, etc., when the housing is in the closed (storage) position.

All components of the device (including the housing) are wipeable and can withstand industrial cleaners. Altogether, the device provides a portable training apparatus that is not only compact and lightweight but also contains all the necessary human components different from other training apparatuses on the market.

The device may be used to practice a urinary catheterization procedure as follows. First, the device 100 may be removed from a storage shelf or other storage area and place on a hospital bed, table, or other work surface. The external lip/flange/handles/hand grips may be used in grasping and carrying of the device. Next, the movable flap 120 may be moved to the second position B, in which the legs 130 and/or torso 140 are in an operative position, outside of the internal volume 112 of the housing 110, as shown in FIGS. 3-5.

To further prepare to practice the procedure, a genitalia accessory 170 may be mounted to the legs/torso 130, 140 by registration of the accessory 170 with the mounting structure 160 on the legs/torso 130/140, if desired, according to the desire to practice catheterization of a male or female.

The procedure can then be practiced by first setting up the catheterization training device 100 by carrying it to a table, bed or suitable work surface, opening the lid of the housing 110 to expose the leg/torso elements. The clinical may then retrieve the desired genitalia accessory from the internal cavity of the housing and secure it on the torso/leg element using the connector 240 such that the genitalia accessory and leg/torso for a continuous urethra model through the genitalia accessory to the bladder, and gather catheter procedure supplies (e.g., including hygiene items and a catheter kit) from the internal cavity of the housing. In accordance with typical procedure, the clinician may then perform hand hygiene and don personal protective equipment (PPI), as appropriate. Next, the clinician may open the outer packaging of the catheter kit and place it in front of the torso/leg element, and open the inner packaging of the catheter kit. According to typical catheterization procedures, the clinician may then use the provided packet of castile soap wipes to cleanse the leg/torso element, discard gloves and perform hand hygiene with provided alcohol hand sanitizer gel. The clinician may then establish a sterile field by using proper aseptic technique, opening wrap, donning sterile gloves provided in the kit, and placing an under pad beneath leg/torso element, plastic or “shiny” side down, taking caution not to contaminate sterile gloves, and positioning a fenestrated drape on leg/torso element appropriately. Next, the clinician may prepare for catheter insertion by opening the iodine packet and pouring the solution onto foam swab sticks to saturate them, attach the water-filled syringe to the inflation port, and using a syringe to deposit lubricant into a tray, remove the Foley catheter from an outer wrap and place the catheter in the lubricant/tray, preparing the leg/torso element with iodine saturated foam swab sticks, using one swab stick for one swipe only and clean the labia/penis portion of the genitalia accessory. The clinician may then insert a distal end of the catheter through the distal portion of the urethra model of the genitalia accessory, and through the proximal portion of the urethra model into the bladder model. The clinician may then inflate the balloon with 10 mL water from a syringe and secure the Foley catheter to the leg/torso element.

After use of the device to practice the procedure (and after catheter insertion is complete, the clinician may clean the torso/leg element and reset the catheterization training device 100 by deflating the catheter's balloon and withdrawing/removing the catheter from the bladder, leg-torso, and genitalia accessory. All elements of the catheterization training device may then be cleaned with professional disposable surface disinfectant “super sani-cloth” wipes containing isopropyl alcohol, including cleaning of the torso/leg element and male/female genitalia accessory. The clinician may then place the cleaning supplies, and other unused supplies, the genitalia accessories, and the torso/leg element back into the housing 110 of the catheterization training device 100, close the lid, and return the housing/device to storage, e.g., by grasping and carrying the device 100 by its external lip/flange/handles/hand grips.

The following detailed description of the invention contains many specifics for the purpose of illustration. Any one of ordinary skill in the art will appreciate that many variations and alterations to the following details are within scope of the invention. Accordingly, the following implementations of the invention are set forth without any loss of generality to, and without imposing limitations upon, the claimed invention.

Accordingly, the device 100 includes the necessary components to create a model representation of an adult human (sufficient for practicing a urinary catheterization procedure) and includes a storage container for all such components. The device includes not only both male and female genitalia model structures needed for practicing insertion of a urinary catheter, but also the lower torso and upper thighs of a human which are involved in steps before and after the actual insertion of the catheter into the bladder via the urethra. Accordingly, this device includes more human anatomical structures that help the provider practice and train for the entire catheterization process from the beginning (creating a sterile field, genitalia prep, equipment prep, etc.) to the end (securing the catheter to the leg, clean up, etc.), rather than just the catheter insertion step.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A catheterization training device comprising:
a rigid housing being configurable in each of a closed configuration in which said housing defines an enclosed internal cavity having a volume, and an open configuration in which said internal cavity is not enclosed,
a body model constructed of lightweight material defining a torso element and a pair of leg elements configured in correspondence to a human body, said body model further comprising:
a urinary bladder model housed within said lightweight material;
a proximal urethra model housed at least partially within said lightweight material, said proximal urethra model defining a first canal in fluid communication with said urinary bladder model and terminating in a connector;
at least one genitalia accessory having a configuration of one of human male and human female genitalia, said at least one genitalia accessory defining a distal urethral model comprising a second canal terminating in a corresponding connector, said corresponding connector being operable to form a mechanical interconnection with said connector of said body model to form a fluid-tight interconnection therewith, and a continuous canal through said distal urethra model and said proximal urethra model and into said urinary bladder model.

2. The catheterization training device of claim 1, wherein at least a portion of said body model is permanently attached to an internal surface of said rigid housing.

3. The catheterization training device of claim 1, wherein at least a portion of said body model is releasably attached to an internal surface of said rigid housing.

4. The catheterization training device of claim 1, wherein said rigid housing comprises a movable flap operable to move between a first position in which said housing is in the closed configuration, and a second position in which said rigid housing is in the open configuration.

5. The catheterization training device of claim 4, wherein at least a portion of said body model is attached to an internal surface of said movable flap.

6. The catheterization training device of claim 1, wherein said rigid housing is dimensioned to accommodate said body model and said at least one genitalia accessory when said rigid housing is in the closed configuration.

7. The catheterization training device of claim 6, wherein said rigid housing is further dimensioned to further accommodate materials associated with at least one of a printed instruction guide, a urinary catheter, adhesive tape, a box of examination gloves, and cleaning materials/wipes.

8. The catheterization training device of claim 1, wherein rigid housing is configured to be stackable by having a box-like shape.

9. The catheterization training device of claim 1, wherein rigid housing is configured to be stackable by having one of a strictly cuboid and a not strictly cuboid shape.

10. The catheterization training device of claim 1, wherein rigid housing defines at least one of an external flange and a handle to facilitate manually grasping of said rigid housing.

11. The catheterization training device of claim 1, wherein said body model is constructed of a sheet material filled with a stuffing material.

12. The catheterization training device of claim 1, wherein said body model is constructed of a fabric-type material selected from a group consisting of vinyl, polyethylene and polypropylene fabric, and said stuffing material is selected from a group consisting of foam and polyester wool filling.

13. The catheterization training device of claim 1, wherein at least one of said torso element and said pair of leg elements comprises a mounting structure, and wherein said at least one genitalia accessory comprises a complementary mounting structure, for mounting said at least one genitalia accessory in an anatomically correct position adjacent a juncture of said pair of leg elements.

14. The catheterization training device of claim 1, wherein said at least one genitalia accessory comprises a female genitalia model accessory and a male genitalia model accessory.

15. The catheterization training device of claim 14, wherein said female genitalia model accessory is fixedly attached to said body model, and wherein said male genitalia model accessory is configured for attachment over said female genitalia accessory by way of a mounting structure.

16. The catheterization training device of claim 1, wherein said urinary bladder model comprises a bottle body and a reclosable matable lid defining an outlet, said lid being configured to form a fluid-tight seal with said bottle body.

17. The catheterization training device of claim 16, wherein said bottle body defines a bladder cavity having a cross-section substantially larger in cross-section than a cross-section of said outlet.

18. The catheterization training device of claim 17, wherein said body model defines a pocket internal to said body model and closable by a reclosable fastener, said pocket being dimensioned to house said urinary bladder model and at least a portion of said proximal urethra model.

19. A catheterization training device comprising:
a rigid housing being configurable in each of a closed configuration in which said housing defines an enclosed internal cavity having a volume, and an open configuration in which said internal cavity is not enclosed, said rigid housing comprising a movable flap operable to move between a first position in which said housing is in the closed configuration, and a second position in which said rigid housing is in the open configuration;
a body model constructed of lightweight material defining a torso element and a pair of leg elements configured in correspondence to a human body, said body model further comprising:
a urinary bladder model housed within said lightweight material;
a proximal urethra model housed at least partially within said lightweight material, said proximal urethra model defining a first canal in fluid communication with said urinary bladder model and terminating in a connector;
at least one genitalia accessory having a configuration of one of human male and human female genitalia, said at least one genitalia accessory defining a distal urethral model comprising a second canal terminating in a corresponding connector, said corresponding connector being operable to form a mechanical interconnection with said connector of said body model to form a fluid-tight interconnection therewith, and a continuous canal through said distal urethra model and said proximal urethra model and into said urinary bladder model.

20. The catheterization training device of claim 19, wherein at least a portion of said body model is attached to an internal surface of said rigid housing.

21. The catheterization training device of claim 20, wherein at least a portion of said body model is attached to an internal surface of said movable flap.

22. The catheterization training device of claim 19, wherein rigid housing is configured to be stackable by having a box-like shape.

23. The catheterization training device of claim 21, wherein said body model is constructed of a sheet material and filled with a stuffing material.

24. The catheterization training device of claim 19, wherein at least one of said torso element and said pair of leg elements comprises a mounting structure, and wherein said at least one genitalia accessory comprises a complementary mounting structure, for mounting said at least one genitalia accessory in an anatomically correct position adjacent a juncture of said pair of leg elements.

25. The catheterization training device of claim 18, wherein said body model defines a pocket internal to said body model and closable by a reclosable fastener, said pocket being dimensioned to house said urinary bladder model and at least a portion of said proximal urethra model.

26. A catheterization training device comprising:
a rigid housing being configurable in each of a closed configuration in which said housing defines an enclosed internal cavity having a volume, and an open configuration in which said internal cavity is not enclosed, said rigid housing comprising a movable flap operable to move between a first position in which said housing is in the closed configuration, and a second position in which said rigid housing is in the open configuration;
a body model constructed of a lightweight sheet material filled with a stuffing material, said body model defining a torso element and a pair of leg elements configured in correspondence to a human body, at least a portion of said body model is attached to an internal surface of said moveable flap, said body model further comprising:
a urinary bladder model housed within said lightweight material;
a proximal urethra model housed at least partially within said lightweight material, said proximal urethra model defining a first canal in fluid communication with said urinary bladder model and terminating in a connector;
at least one genitalia accessory having a configuration of one of human male and human female genitalia, said at least one genitalia accessory defining a distal urethral model comprising a second canal terminating in a corresponding connector, said corresponding connector being operable to form a mechanical interconnection with said connector of said body model to form a fluid-tight interconnection therewith, and a continuous canal through said distal urethra model and said proximal urethra model and into said urinary bladder model.

27. The catheterization training device of claim 19, wherein rigid housing is configured to be stackable by having a box-like shape.

28. The catheterization training device of claim 18, wherein said body model defines a pocket internal to said body model and closable by a reclosable fastener, said pocket being dimensioned to house said urinary bladder model and at least a portion of said proximal urethra model.
